(19) United States
(12) Patent Application Publication
(10) Pub. No.: US 2006/0268882 A1
(43) Pub. Date: Nov. 30, 2006

(54) Transmission of information (nack) by a subscriber terminal with respect to the reception of a data block in a point-to-multipoint radio transmission system

(76) Inventor: Frank Mademann, berlin (DE)

Correspondence Address: STAAS & HALSEY LLP, SUITE 700, 1201 NEW YORK AVENUE, N.W., WASHINGTON, DC, 20005, US

(21) Appl. No.: 10/573,758

(22) PCT Filed: Aug. 27, 2004
(86) PCT No.: PCT/EP04/51943

§ 371 Date: Mar. 29, 2006

(30) Foreign Application Priority Data
Sep. 29, 2003 (EP) 03425632.1

(51) Int. Cl. H04L 12/56

(52) U.S. Cl. 370/394; 370/310

(57) ABSTRACT

When at least one data block is transmitted from a base station to subscriber terminals according to a point-to-multipoint transmission, a request on the signalling of information with respect to the respective reception of the data block to a selected group from the receiving subscriber terminals is transmitted by the base station. At least one subsequent transmission of a data block is initiated by the base station according to information received from the selected group of subscriber terminals.

### CROSS REFERENCE TO RELATED APPLICATIONS

This application is based on and hereby claims priority to European Application No. 03425632 filed on Sep. 29, 2003, the contents of which are hereby incorporated by reference.

### BACKGROUND OF THE INVENTION

1. Field of the Invention

The invention relates to a method for transmission of data in a radio communication system, especially in a mobile radio system. The invention also relates to a radio communication system, a base station and a subscriber terminal for executing the method in accordance with the invention.

2. Description of the Related Art

In radio communication systems, for example the European Mobile Radio System of the second generation GSM (Global System for Mobile Communications), information (for example, voice, video information or other data) is transmitted with the aid of electromagnetic waves via a radio interface. The radio interface refers to a link between a base station and subscriber terminals, whereby the subscriber terminals can be mobile stations or fixed radio stations. The radiation of electromagnetic waves in this case takes place at carrier frequencies that lie in the frequency band provided for the particular system. Further developments based on the GSM system, known under the term GPRS or EDGE, for the transmission of higher data rates, are known as 2.5 generation. Radio communication systems, such as UMTS (Universal Mobile Telecommunication System) or other systems of the third generation are designed for higher data rates compared to the second generation. Two modes are provided for the third mobile radio generation, with one mode being called an FDD (Frequency Division Duplex) mode and the other a TDD (Time Division Duplex) mode. These modes are each used in different frequency bands, during which process they each support a CDMA (Code Division Multiple Access) method.

As part of the standardization of network functionalities of the UTRAN (UMTS Terrestrial Radio Access Network) and GERAN (GSM EDGE Radio Access Network) by 3GPP (3^{rd} Generation Partnership Project), support of what is referred to as an MBMS (Multimedia Broadcast/Multicast Service) is defined. Further details are given in the technical specification 3GPP TS 22.146 V6.2.0 (2203-03) and 3GPP TS 23.246 V1.1.0 (2003-07). The object of the MBMS is to be able to make multimedia data with a typically high data rate available simultaneously to a number of subscribers by unidirectional point-to-multipoint transmission over common channels with only one MBMS radio channel being advantageously used per radio cell. Advantageously in this manner the multiple transmission of the same data on several point-to-point links or channels is avoided.

MBMS distinguishes between two applications of multimedia data transmission, multicast and broadcast. A multicast service in this case represents a unidirectional point-to-multipoint service in which data can be received by subscribers of a group that have appropriate authorization to receive the service, for example on the basis of a subscription. In contrast to this, with a broadcast service all subscribers that are within the range of the transmission of the service receive data of this service. Further definitions and descriptions of the differences are given particularly in chapters 3.1, 4.1 and 4.2 of the above TS 22.146.

Error-free reception of data is ensured by an FEC (Forward Error Correction) at the transmission end, i.e. by adding redundancy, and by a high transmission power. Despite these precautions, cases can occur where data blocks are not correctly received or detected, particularly with subscribers that are a great distance from the transmitting base station or where reception is impaired by shadowing or high interference. This is unacceptable particularly from the point of view of subscribers paying the multicast service fees. It is also disadvantageous that the forward error correction is realized independent of varying reception conditions and transmission resources cannot therefore be efficiently used, and that because of the constant high transmission power a strong interference influence on parallel signal transmissions occurs.

### SUMMARY OF THE INVENTION

An object of the invention is therefore to provide a method and system components that enable an improved reception of data with a more efficient use of transmission resources.

According to the invention, at least one data block is transmitted from a base station to a plurality of subscriber terminals according to a point-to-multipoint transmission. The invention is characterized in that a request for the signaling of information with respect to the respective reception of the data block is transmitted to a selected group from the plurality of receiving subscriber terminals by the base station and that at least one subsequent transmission of a data block is initiated by the base station according to information received from the selected group of subscriber terminals.

The information in this case can be status information. A mechanism is advantageously introduced in this way which enables status information from subscriber terminals to be obtained at the network end, evaluated and, if necessary, enables measures to be deduced, for example for matching the data transmission.

The method for the transmission of the data block can be particularly advantageously used in a channel allocated to a broadcast and/or multicast service, as described in the introduction.

If the number of subscriber terminals receiving the data block is too great or exceeds a specified threshold value, this number can then at least be roughly determined by the network when setting up the MBMS, thus, according to the invention, the signaling of information with respect to the reception of the data block by a selected group of subscriber terminals whose reception situation is to be evaluated, is requested by signaling from the base station, for example by polling. This is particularly advantageous if due to the large number of receiving subscriber terminals the probability of a collision in the event of transmission of requested information is high.

The at least one subsequent transmission of the data block relative to the information of the selected group of subscriber terminals advantageously enables all the receiving subscriber terminals in the radio coverage area of the base station to be able to receive or detect this data block more reliably. According to an advantageous embodiment, the error protection or transmission power of the base station can be increased on a subsequent transmission. Furthermore, known methods, such as incremental redundancy, can be advantageously used.

According to an embodiment of the invention, the information regarding the reception of the data block can be signaled to the base station in a channel used jointly by a plurality of subscriber terminals.

In contrast to the known point-to-point links, in which, for example ARQ (Automatic Repeat Requests) mechanisms are used, the method in accordance with the invention of using a common channel means that it is not necessary to set up a plurality of channels corresponding to the number of subscriber terminals for transmission of information, with the advantage that the limited number of radio resources can be more efficiently used. The channel can, for example, be either a common signaling channel or a dedicated channel (DCH), with the latter advantageously avoiding interference or overloading of the common signaling channel. The information signaled on the channel is, for example, evaluated in a base station controller at a higher level than the base station, particularly in the RLC (Radio Link Control).

According to a further development of the invention, an access burst or at least a signaling radio burst with at least a number of properties of an access burst is transmitted as information from the subscriber terminal to the base station.

An access burst of this kind has the advantage that it can be easily detected at the receiver end because of a long training sequence, even if collisions of signaling occur due to simultaneous access on the common channel. Furthermore, an access burst of this kind is constructed in such a way that precise matching of the transmitting subscriber terminal to the time structure of the base station is not necessary. In particular, if the invention is used in a TDMA-based system, this makes the advantageous use of the method possible, even if due to the current absence of bidirectional communication absolutely no time synchronization (timing advance as it is called) of the subscriber terminal can take place by the base station. In the case of a CDMA-based system, separation of information from several subscriber terminals can take place at the receiving end, for example by using different channelization codes, with the channelization codes being, for example, selected, randomly controlled, by the subscriber terminals.

In a further development of the invention, the information signals an incorrect reception, or no reception, of the data block. Signaling only in the event that a data block is not correctly received, or was not detected, advantageously reduces the information signaling load. The base station or the system for example receives only status information that, for instance, can be executed in the access burst previously described. If on the other hand, it is intended to signal an incorrect reception of other information, in addition to or instead of the status information, for example correct reception of each data block, this can, for example, be controlled by a time division of the signaling resource into time slots, that are assigned to one of the particular plurality of subscriber terminals.

By dividing a data block into a number of bursts, according to GPRS, for example into four bursts, four corresponding bursts for signaling information to the base station can, for instance, be used by four different subscriber terminals or groups of subscriber terminals, so that the probability of collisions is further advantageously reduced. Alternatively, access to the resources is randomly controlled, for example in accordance with the known ALOHA protocol. In accordance with a further alternative, the corresponding radio bursts of a physical point-to-multipoint channel can be allocated to a number of physical point-to-point multipoint channels that jointly form a logical MBMS channel, i.e. subscriber terminals that receive data blocks on four physical point-to-multipoint channels signal the information regarding the reception of data blocks in each case in four under-resources of a common backward channel. The advantage of this is that a separate backward channel is not established for each established physical point-to-multipoint channel, and this in turn enables more efficient use of the limited radio resources. Furthermore, the transmission rate for transmission in the downlink direction to the subscriber terminals can be expanded compared with the transmission rate of the backward channel, if a system-required upper limit of the sum of the physical channels of both transmission directions is used as a basis.

If, for example, reception or detection of information by the base station is not possible due to collisions of information of several subscriber terminals, the detection of an increased signaling load on the backward channel can be interpreted to mean that the transmitted data block was not correctly received by a plurality of subscriber terminals, and a further transmission of the data block can be initiated. The detection of the increased signaling load can, moreover, be achieved, for example by measuring the signal level in the backward channel.

In accordance with a further development of the invention, the initiation of a possible transmission of a data block takes place relative to a service and/or parameters allocated to a service. Such parameters can, for example, refer to the QoS (Quality of Service), i.e. specifications, for instance, regarding the maximum permitted delay or bit or block error rate.

Realtime services and non-realtime services moreover place different requirements on the transmission, which must be allowed for in the control of repeat transmission. Thus, for example, with a realtime service only one or a few repeat transmissions of a data block are possible because otherwise a preset maximum transmission time cannot be complied with, whereas with non-realtime services a higher, or any, number of repeat transmissions up to a correct detection by all the receiving subscriber terminals is absolutely possible. If the requirements regarding the bit or block error rate is low, a specification of a threshold value can be useful either as an addition or alternative. This threshold value, for example, signifies an absolute or relative number of items of received information from the subscriber terminals that must be exceeded in order to initiate a repeat transmission of the data block. This threshold value can be changed as required on each repeat transmission.

The transmission of a succeeding data block takes place in accordance with a further development of the invention at preset time intervals, in which the information of the subscriber terminals can be received, i.e. there is a definite time relationship between the transmission time point for a data block and the timepoint at which associated information may be sent to the subscriber terminals.

Due to this time interval, that for example is dimensioned according to a maximum possible delay of the transmission of the information based on the size of the radio cell of the base station, the numbering of data blocks, or of the related information, that would otherwise be necessary, can advantageously be disregarded because the time sequence of the transmission of the data blocks does not change and the relative position of the data block and associated status information advantageously remains unchanged. If the base station receives one or more items of information, for example, referring to an incorrect reception of the data block, the data block is repeatedly transmitted until no, or only a specific number of items of information is received, and only then is a subsequent data block transmitted.

According to a further development, the transmission power of the base station is controlled relative to the received information with respect to receipt of the data block. After the establishment, for example, of an MBMS channel, the transmission of a data block initially takes place at a certain transmission power. If no information is subsequently received from the subscriber terminals, the transmission power is reduced. This procedure can be continued for succeeding data blocks until one item, or a specific number of items, of information are received from the subscriber terminals. If this number exceeds a specified threshold value, the transmission power is correspondingly increased again. By using two threshold values a range in which the transmission power controller can move between a top and bottom limit can be defined, whereby it is possible to flexibly adapt, or permanently configure, the threshold values on the basis of the variable reception situations due to the movement of the subscriber terminals. Based on the result of this transmission power control, the number of items of status information or the reception level on the backward channel, the transmission power of the subscriber terminals can also be controlled by signaling from the base station, for example by specifying a maximum transmission power to be used, which in turn advantageously reduces the interference on the radio interface.

The radio communication system, the base station and the subscriber terminals in accordance with the invention each perform the method in any of the previously described configurations.

### BRIEF DESCRIPTION OF THE DRAWINGS

These and other objects and advantages of the present invention will become more apparent and more readily appreciated from the following description of an example of an embodiment, taken in conjunction with the accompanying drawings of which:

FIG. 1 is a block diagram of an example of a radio communication system

FIG. 2 is a flow diagram of the method in accordance with the invention

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

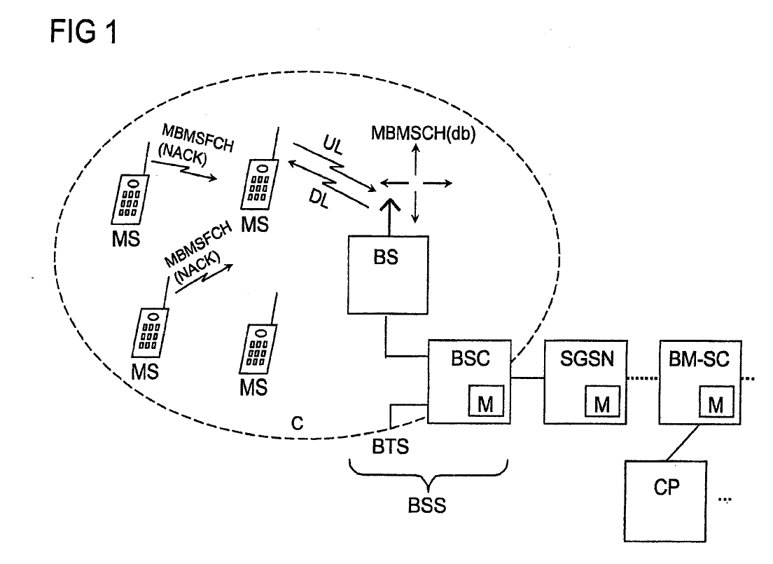

FIG. 1 shows a block diagram of the structure of a known radio communication system, such as, for example, is realized in the described GSM or UMTS mobile radio system. The aforementioned technical specification 3GPP TS 23.246 V1.1.0 (2003-07) shows, in chapter 4.2 an example of an architecture reference model in which the invention can be used. In contrast, individual components of the system are designated in FIG. 1 according to the known GSM nomenclature.

A base station BS (Base Transceiver Station) illuminating at least one radio cell C is connected via a base station controller BSC (Base Station Controller) to a mobile switching centre MSC (Mobile Switching Center) (not illustrated). The main task of the base station controller BSC is the central allocation of radio resources of several connected base stations BS. The combination of base stations BS and a base station controller BSC is also known as a BSS (Base Station System). Each base station BS can, by using allocated radio resources, establish or release connections to subscriber terminals MS (Mobile Station), for example mobile or stationery terminals. Moreover, a distinction is made during the transmission via the named interfaces between UL (Uplink) and DL (downlink) directions.

The base station controller BSC is also connected through a SGSN (Serving GPRS Support Node) and a GGSN (Gateway GPRS Support Node) with a BM-SC (Broadcast-Multicast Service Centre). The functionalities of these devices are described mainly in chapters 5.1, and 5.4 of the technical specification 3GPP TS 23.246 V1.1.0 (2003-07). The BM-SC in this case, for example, serves as an access interface for CP (Service or Content Providers) and to initiate the establishment of MBMS channels and the time control of the data transmission on these channels. The SGSN on the other hand has network control functions for the transmission of MBMS data. Further components of the system, not described in more detail here, can also be used to realize the MBMS service.

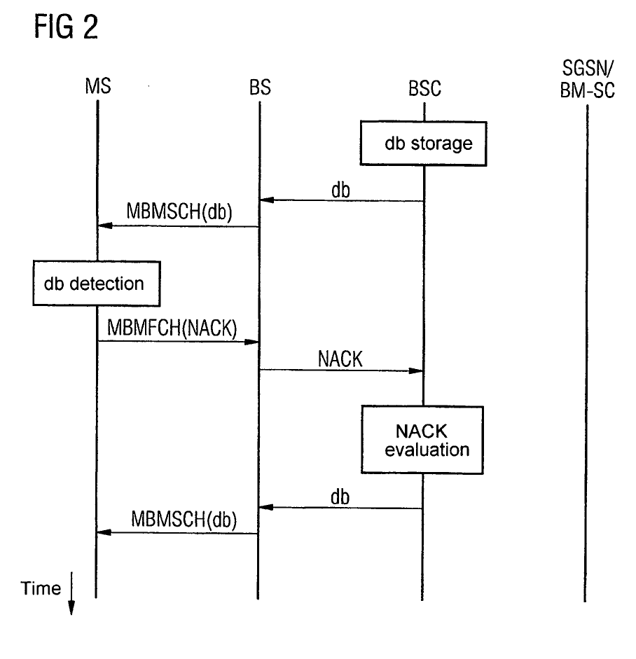

The setup procedures of an MBMS service are carried out in accordance with the procedure described in chapter 8 of the technical specification 3GPP TS 23.246 V1.1.0 (2003-07, and is again described separately in the following description of the illustrations. FIGS. 1 and 2 show a simplified representation of how a single data block db is transmitted from the base station system BSS, including, for example, a base station controller BSC and a base station BS, to a plurality of subscriber terminals MS. An incoming data block db of a service to the base station controller via the SGSN or BM-SC in the base station controller is stored in a memory M and forwarded to the base station BS covering the subscriber terminals MS. As shown in the example in the illustration, this memory M for storage of the data block db can in a similar manner be stored in the SGSN, BM-SC and/or also in the base station BS, with saving at a high hierarchical level advantageously saving storage costs in the lower levels and storage at a lower level saving the subsequent transmission via several network components. The advantages and disadvantages of these two are to be weighed when arranging the memory. The storage of the data block db continues up to the successful detection by the subscriber terminals MS or until a specified time interval, in which repeated transmissions can be performed, has elapsed or a predetermined maximum number of repetitions is reached.

From the base station BS, the data block db is transmitted in a specially set up MBMS channel MBMSCH via the radio interface to a plurality of subscriber terminals MS and received and detected by these. If, as shown in FIGS. 1 and 2, one or more of the receiving terminals MS detects that the data block db could not be correctly received or detected, or that despite the notification when setting up the MBMS no data block was received, the particular subscriber terminal MS signals this in a backward channel MBMSFCH (MBMS Feedback Channel) allocated to the MBMS channel MBMSCH. The signaling of the incorrect reception takes place, for example, by a negative confirmation signaling NACK (Non-Acknowledgement) known from the ARQ method. This negative confirmation signaling NACK can in this case take place advantageously in the form of radio bursts that correspond to access bursts, called RACH bursts, or have the properties of access bursts. Such properties are, for example, a long training sequence to improve detection in the event of the occurrence of collisions with other signaling and a short overall length, so that only a rough synchronicity with the time structure of the transmitting base station BS is necessary. An exclusive signaling of negative confirmation NACK has the advantage that the signaling load in the backward channel is limited and thus the probability of collisions between signaling of randomly controlled subscriber terminals accessing the backward channel is reduced.

The efficiency of the use of the backward channel MBMSFCH can furthermore be increased in that a common backward channel is provided for several physical MBMS channels that form a logic MBMS channel. In the example of the application of the invention in a GPRS system, a data block is transmitted in four radio bursts. Correspondingly, each of the four physical MBMS channels can, for example, each be allocated one radio burst of the backward channel, which also contains four radio bursts in the time period of one data block, of which, however, one access burst is sufficient for signaling status information related to a data block. As an alternative, or addition, when configuring with a backward channel for each MBMS channel the access of the subscriber terminals to the individual radio burst can also be randomly controlled, which advantageously further reduces the probability of collisions. If the number of subscribers is very large, it is further the responsibility of the radio system to request the signaling of negative confirmations from only a certain number or group of subscriber terminals, to thus reduce the probability of collisions and the signaling load on the backward channel. This method is also known as polling.

After evaluation of the negative confirmation signaling NACK in the base station controller BSC, a further transmission of the stored data block db to the base station BS and transmission in the MBMS channel MBMSCH to the subscriber terminals MS takes place. The evaluation of the information of the subscriber terminals, in this case the negative confirmation signaling, by the RLC (Radio Link Control) in the base station BSC can take place in such a way that a repeat transmission of this data block is initiated only after a specific number of received NACKs for a data block. If no negative confirmation signaling is received by the base station BS, for example due to collisions when accessing the common backward channel MBMSFCH, a simple determination of the reception level on the backward channel is also adequate as an alternative for determining the requirement of the subscriber terminals for a repeated transmission of the data block. Moreover, it is advantageous to provide a specific time interval after each transmission of a data block db, in which the subscriber terminals can signal status information NACKs to the covering base station BS. This enables the specification of numbers of data blocks db to be omitted in the signaling of subscriber terminals, because the time relationship between the transmission of the particular data block and the transmission of the corresponding status information is not changed.

The number of received negative confirmation signalings NACK for initiation of a repeat transmission of the data block db can advantageously be defined relative to the service or requirements of the service. Thus, for example, with multicast services for which the subscriber sometimes pays high fees, a repeat transmission can also be relevant even when only one negative confirmation is received, in order to prevent customer dissatisfaction. In contrast, with cost-less services a repeat transmission is, for example, only purposeful after a specific absolute or relative amount of incorrectly receiving subscriber terminals, in order not to allow the delays or transmission time to become too great. The maximum number of repeat transmissions of a data block can be configured in a similar manner depending on the service or service parameters. QoS (Quality of Service) requirements, such as maximum tolerated transmission delays or transmission time and bit or block error rate are moreover to be also taken into account in the same way as the type, realtime or non-realtime, of service.

The actual reception, or the number, of confirmation signalings from the subscriber terminals MS can advantageously be taken into account for a transmission power control of the transmission in the MBMS channel MBMSCH. If, after transmitting a data block db, the base station system does not receive a negative confirmation signaling NACK, the transmission power of the base station BS is reduced for the transmission of a succeeding data block db. This, for example, continues in succession until a first, or certain number of, negative confirmation signalings of the subscriber terminals is received. If the number of signalings again exceeds a specific threshold value, the transmitter power is again successively increased. Because the definition of a lower and upper threshold value can vary, a range can be defined in which the transmission power of the base station can also vary. In addition, depending on these evaluations or on a specific signal level of the backward channel, a maximum transmitter power of the subscriber terminals MS can, for example, be defined and signaled to the subscriber terminals MS, whereby the effective interference due to parallel signal transmissions can be advantageously reduced.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-12. (canceled)

13. A method for transmission in a radio communication system of at least one data block from a base station to a plurality of subscriber terminals in accordance with a point-to-multipoint transmission, comprising:
transmitting, by the base station to a selected group from receiving subscriber terminals, an explicit request for signaling of information with respect to reception of the at least one data block; and
initiating at least one subsequent transmission of one of the at least one data block by the base station according to the information received from the selected group of subscriber terminals.

14. A method in accordance with claim 13,
wherein the at least one data block is allocated to at least one of a unidirectional broadcast and a multicast service, and
further comprising transmitting the at least one data block in a channel allocated to the at least one of a unidirectional broadcast and a multicast service.

15. A method in accordance with claim 14, wherein the information regarding the reception of the at least one data block is signaled to the base station in a channel that can be commonly used by the subscriber terminals.

16. A method in accordance with claim 15, further comprising transmitting one of an access burst and a signaling burst having a number of properties of an access burst as the information initiating the subsequent transmission of the data block.

17. A method in accordance with claim 16, wherein the information with respect to the reception of the at least one data block signals that the at least one data block was one of incorrectly received and not received.

18. A method in accordance with claim 13, wherein said initiating of the at least one subsequent transmission of the data block occurs at a network end depending on at least one of a service and parameters allocated to the service.

19. A method in accordance with claim 18, further comprising transmission of a successive data block in accordance with a specified time interval for reception of the information of one of the subscriber terminals.

20. A method in accordance with claim 19, further comprising controlling a transmission power of the base station depending on at least one of the information and a reception strength of the information at the base station.

21. A radio communication system communicating with subscriber terminals, comprising:
at least one base station transmitting a data block to a multiplicity of the subscriber terminals in a coverage area of said base station in accordance with a point-to-multipoint transmission and transmitting an explicit request for signaling of information with respect to a particular reception of at least one data block to a selected group of the multiplicity of subscriber terminals; and
at least one device evaluating the information received form the selected group of subscriber terminals and initiating at least one repeat transmission of the at least one data block to the multiplicity of subscriber terminals according to a result of the evaluating.

22. A radio communication system in accordance with claim 21, wherein the at least one device includes a storage device holding the at least one data block for subsequent transmission to the multiplicity of subscriber terminals.

23. A base station of a radio communication system communicating with subscriber terminals, comprising:
means for sending at least one data block to a plurality of the subscriber terminals in a coverage area of said base station in accordance with a point-to-multipoint transmission and for transmitting an explicit request for signaling of information with respect to a particular reception of the at least one data block to a selected group of the plurality of subscriber terminals; and
means for receiving information from the selected group of subscriber terminals, said means for sending configured for subsequent sending of the at least one data block according to the information received form the selected group of subscriber terminals.

24. A subscriber terminal communicating with a base station of a radio communication system, comprising:
means for receiving at least one data block transmitted from the base station of the radio communication system according to a point-to-multipoint transmission and an explicit request for signaling of information with respect to a reception of the at least one data block to a plurality of subscriber terminals;
means for generating the information with respect to the reception of the at least one data block; and
means for signaling the information with respect to the reception of the at least one data block to the base station.
